(19) United States
(12) Patent Application Publication
(10) Pub. No.: US 2022/0266684 A1
(43) Pub. Date: Aug. 25, 2022

(54) FUEL FILLER PORT AND METHOD OF MANUFACTURING THE SAME

(71) Applicant: Sumitomo Riko Company Limited, Aichi (JP)

(72) Inventors: Eunjin PARK, Aichi (JP); Makoto SHIMOJO, Aichi (JP); Takayuki KOBAYASHI, Aichi (JP); Kazushige SAKAZAKI, Aichi (JP)

(73) Assignee: Sumitomo Riko Company Limited, Aichi (JP)

(21) Appl. No.: 17/671,508

(22) Filed: Feb. 14, 2022

(30) Foreign Application Priority Data
Feb. 25, 2021 (JP) 2021-028060
Dec. 23, 2021 (JP) 2021-209697

(51) Int. Cl. B60K 15/04

(52) U.S. Cl. CPC B60K 15/04; B60K 2015/03453

(57) ABSTRACT

A fuel filler port includes a resin fuel filler port main body formed tubular and having an interlock part on an outer circumferential surface thereof; an inlet metal fitting at least having an outer tube part formed tubular, positioned and disposed in the fuel filler port main body, and disposed to face the outer circumferential surface of the fuel filler port main body in a radial direction; and an earth metal fitting formed in a plate shape and interlocked with the interlock part. The earth metal fitting includes a tip bent part disposed between the outer circumferential surface of the fuel filler port main body and an inner circumferential surface of the outer tube part in the radial direction and disposed while having a biasing force in the radial direction with respect to the inner circumferential surface of the outer tube part.

### CROSS-REFERENCE TO RELATED APPLICATION

This application claims the priority benefit of Japan application serial no. 2021-209697, filed on Dec. 23, 2021, which claims the priority benefit of Japan Patent Application No. 2021-028060, filed on Feb. 25, 2021. The entirety of each of the above-mentioned patent applications is hereby incorporated by reference herein and made a part of this specification.

### BACKGROUND

### Technical Field

The disclosure relates to a fuel filler port and a method of manufacturing the same.

### Description of Related Art

In the fuel filler port described in Patent Document 1, a conductive layer having conductivity is formed on an outer circumferential surface by performing two-color forming of a fuel filler port main body made of resin. An inlet metal fitting comes into contact with the conductive layer, and therefore an earth route is secured.

In the fuel filler port described in Patent Document 2, an earth terminal is attached to an outer circumferential end of an inlet metal fitting mounted in a fuel filler port main body, and therefore an earth route is secured. In the fuel filler port described in Patent Document 3, an earth terminal is fixed to an outer circumferential surface of an inlet metal fitting mounted in a fuel filler port main body, an insertion terminal of an earth wire is coupled to the earth terminal, and therefore an earth route is secured.

### PATENT DOCUMENTS

[Patent Document 1] Japanese Patent No. 6156184

[Patent Document 2] Japanese Examined Utility Model Application, Second Publication No. H7-27225

[Patent Document 3] Japanese Examined Utility Model Application, Second Publication No. H7-8279

In the fuel filler port described in Patent Document 1, since a conductive layer is formed by performing two-color forming, there is a need to use a large amount of expensive conductive fillers, thereby resulting in high costs. In the fuel filler port described in Patent Document 2, there is room for improvement in reliably performing positioning of an earth terminal and reliably performing electrical connection between an inlet metal fitting and the earth terminal. In the fuel filler port described in Patent Document 3, there is room for improvement in reliably performing electrical connection between an inlet metal fitting and an earth terminal.

### SUMMARY

According to one aspect of the disclosure, there is provided a fuel filler port including a fuel filler port main body made of resin, formed in a tubular shape and having an interlock part on an outer circumferential surface thereof; an inlet metal fitting at least having an outer tube part, the outer tube part being formed in a tubular shape, positioned and disposed in the fuel filler port main body, and disposed to face the outer circumferential surface of the fuel filler port main body in a radial direction; and an earth metal fitting formed in a plate shape and interlocked with the interlock part of the fuel filler port main body. The earth metal fitting includes a tip bent part disposed between the outer circumferential surface of the fuel filler port main body and an inner circumferential surface of the outer tube part of the inlet metal fitting in the radial direction and disposed in a state of having a biasing force in the radial direction with respect to the inner circumferential surface of the outer tube part of the inlet metal fitting.

According to another aspect of the disclosure, there is provided a method of manufacturing the foregoing fuel filler port. The method includes a positioning step in which the outer tube part of the inlet metal fitting is positioned at a position facing the outer circumferential surface of the fuel filler port main body and the tip bent part of the earth metal fitting is rendered in a state of having a biasing force in the radial direction between the outer circumferential surface of the fuel filler port main body and the inner circumferential surface of the outer tube part of the inlet metal fitting in the radial direction, and a caulking step in which the outer tube part is interlocked with the outer circumferential surface of the fuel filler port main body in the axial direction by deforming the outer tube part radially inward.

### BRIEF DESCRIPTION OF THE DRAWINGS

FIG. 1 is a view of a fuel line.

FIG. 2 is a perspective view of a fuel filler port according to Embodiment 1.

FIG. 3 is a side view of a fuel filler port main body constituting the fuel filler port.

FIG. 4 is a top view of the fuel filler port main body and is a view in the direction IV in FIG. 3.

FIG. 5 is a cross-sectional view in an axial direction of the fuel filler port main body and is a cross-sectional view along V-V in FIG. 4.

FIG. 6 is a cross-sectional view in a radial direction of the fuel filler port main body and is a cross-sectional view along VI-VI in FIG. 5.

FIG. 7 is an enlarged view of the part VII in FIG. 5.

FIG. 8 is an enlarged view of the part VIII in FIG. 6 and is a cross-sectional view along VIII-VIII in FIG. 7.

FIG. 9 is a cross-sectional view in the axial direction of an inlet metal fitting constituting the fuel filler port.

FIG. 10 is a top view of an earth metal fitting constituting the fuel filler port.

FIG. 11 is a side view of the earth metal fitting.

FIG. 12 is a flowchart showing a method of manufacturing a fuel filler port.

FIG. 13 is a cross-sectional view in the axial direction of the fuel filler port in an earth metal fitting attaching step.

FIG. 14 is a view in the direction XIV in FIG. 13.

FIG. 15 is a cross-sectional view in the axial direction of the fuel filler port in an inlet metal fitting attaching step.

FIG. 16 is a view in the XVI direction in FIG. 15.

FIG. 17 is an enlarged view of the part XVII in FIG. 15.

FIG. 18 is a cross-sectional view in the axial direction of the fuel filler port in a caulking step.

FIG. 19 is an enlarged view of the part XIX in FIG. 18.

FIG. 20 is a cross-sectional view in the radial direction of the fuel filler port illustrating a state before caulking in the caulking step.

FIG. 21 is a cross-sectional view in the radial direction of the fuel filler port illustrating a state after caulking in the caulking step.

FIG. 22 is a cross-sectional view in the radial direction of the fuel filler port illustrating another example in a state before caulking in the caulking step.

FIG. 23 is a cross-sectional view in the radial direction of the fuel filler port illustrating a state before caulking in the caulking step of the fuel filler port according to Embodiment 2.

FIG. 24 is a cross-sectional view in the radial direction of the fuel filler port illustrating a state after caulking in the caulking step of the fuel filler port according to Embodiment 2.

FIG. 25 is a side view of the fuel filler port main body constituting the fuel filler port according to Embodiment 3.

FIG. 26 is a top view of the fuel filler port main body constituting the fuel filler port according to Embodiment 3 and is a view in the direction XXVI in FIG. 25.

FIG. 27 is an enlarged view of the part XXVII in FIG. 25.

FIG. 28 is a cross-sectional view along XXVIII-XXVIII in FIG. 27.

FIG. 29 is a partial enlarged cross-sectional view in the axial direction of the fuel filler port main body constituting the fuel filler port according to Embodiment 4.

FIG. 30 is a cross-sectional view along XXX-XXX in FIG. 29.

FIG. 31 is a partial enlarged top view of the earth metal fitting constituting the fuel filler port according to Embodiment 4.

FIG. 32 is a partial enlarged cross-sectional view in the axial direction of the fuel filler port main body and the earth metal fitting constituting the fuel filler port according to Embodiment 4.

FIG. 33 is a partial enlarged cross-sectional view in the axial direction of the fuel filler port main body constituting the fuel filler port according to Embodiment 5.

FIG. 34 is a cross-sectional view along XXXIV-XXXIV in FIG. 33.

FIG. 35 is a partial enlarged cross-sectional view in the axial direction of the fuel filler port main body and the earth metal fitting constituting the fuel filler port according to Embodiment 5.

FIG. 36 is a cross-sectional view along XXXVI-XXXVI in FIG. 35.

FIG. 37 is a side view of the earth metal fitting constituting the fuel filler port according to Embodiment 6.

FIG. 38 is a side view of the earth metal fitting constituting the fuel filler port according to Embodiment 7.

### DESCRIPTION OF THE EMBODIMENT

### Embodiment 1

1. Configuration of Fuel Line 1

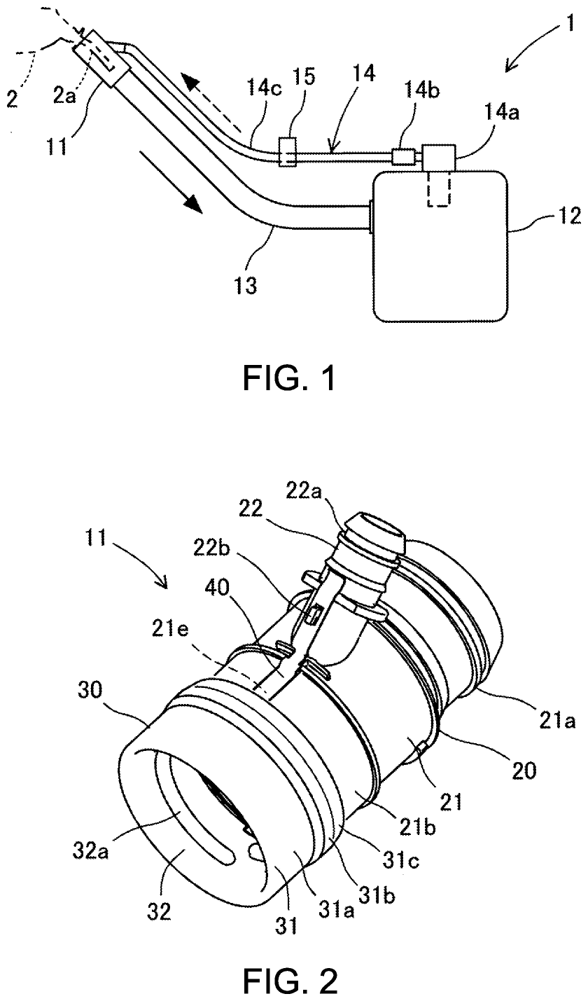

A configuration of a fuel line 1 will be described with reference to FIG. 1. The fuel line 1 is a line from a fuel filler port 11 to an internal-combustion engine (not illustrated) in an automobile. However, in the present embodiment, a section from the fuel filler port 11 to a fuel tank 12 (a portion of the fuel line 1) will be described.

The fuel line 1 includes the fuel filler port 11, the fuel tank 12, a filler pipe 13, and a breather line 14. The fuel filler port 11 is provided in the vicinity of an outer surface of the automobile through which a nozzle 2a of a fuel filler gun 2 can be inserted into. Regarding the fuel filler port 11, there are a fuel filler cap mounted type (not illustrated) and a capless type having no fuel filler cap mounted therein. The fuel tank 12 stores liquid fuel such as gasoline. Liquid fuel stored in the fuel tank 12 is supplied to the internal-combustion engine (not illustrated) and is used for driving the internal-combustion engine.

The filler pipe 13 is formed using an elongated resin hose (also referred to as a resin tube). However, as necessary, the filler pipe 13 can also include a joint for connecting hoses to each other. The filler pipe 13 connects the fuel filler port 11 and the fuel tank 12 to each other and causes supplied liquid fuel to circulate in a forward direction. When the nozzle 2a of the fuel filler gun 2 is inserted into the fuel filler port 11 and liquid fuel is supplied from the nozzle 2a, the liquid fuel passes through the filler pipe 13 and is stored in the fuel tank 12. Here, when the fuel tank 12 is filled up with liquid fuel, the liquid fuel is stored in the filler pipe 13, and when liquid fuel comes into contact with a tip of the nozzle 2a of the fuel filler gun 2, supply of the liquid fuel through the nozzle 2a is automatically stopped (an automatic stop function).

The breather line 14 connects the fuel tank 12 and the fuel filler port 11 to each other. The breather line 14 is a line for discharging fuel vapor inside the fuel tank 12 to the outside of the fuel tank 12 when liquid fuel is supplied to the fuel tank 12 via the filler pipe 13.

The breather line 14 includes a cut valve device 14a, a connector 14b, and a breather pipe 14c. The cut valve device 14a is disposed at an upper part of the fuel tank 12 and discharges fuel vapor inside the fuel tank 12 to the fuel filler port 11 side when in an open state. The connector 14b is coupled to a connection pipe of the cut valve device 14a in an attachable/detachable manner. The breather pipe 14c (which will also be referred to as a breather tube or a breather hose) is formed using an elongated resin hose (which will also be referred to as a resin tube). However, as necessary, the breather pipe 14c can also include a joint for connecting hoses to each other. This breather pipe 14c connects the connector 14b and the fuel filler port 11 to each other.

In addition, during fuel filling, when the fuel tank 12 is filled up and the automatic stop function operates, liquid fuel flows back to the fuel filler port 11 from the fuel tank 12 via the breather pipe 14c. In this manner, the breather pipe 14c allows circulation of fuel vapor during fuel filling and reflow of liquid fuel at the time of the automatic stop.

Moreover, the breather pipe 14c is fixed to a body of the automobile by a metal bracket 15. Here, since an inlet of the fuel filler port 11 comes into contact with the fuel filler gun 2, a metal inlet metal fitting (which will be described below) is provided. An earth route is secured in the inlet metal fitting. For example, the earth route is connected to the body of the automobile via an outer circumferential surface of the breather pipe 14c and the metal bracket 15 from the inlet metal fitting. However, the earth route may be connected thereto via the filler pipe 13 in place of the breather pipe 14c.

2. Overview of Configuration of Fuel Filler Port 11

An overview of a configuration of the fuel filler port 11 illustrated in FIG. 1 will be described with reference to FIG. 2. The fuel filler port 11 includes a resin fuel filler port main body 20, an inlet metal fitting 30, and an earth metal fitting 40. In the present embodiment, regarding the fuel filler port 11, a fuel filler cap mounted type is presented as an example, but a capless type can also be applied. The fuel filler port 11 may include a nozzle guide (not illustrated).

The nozzle 2a of the fuel filler gun 2 (illustrated in FIG. 1) is inserted into the fuel filler port main body 20, and is connected to the filler pipe 13 and the breather pipe 14c. The fuel filler port main body 20 includes a main tube part 21 and a sub-tube part 22 which branches and is connected at an intermediate position in the main tube part 21. For example, the fuel filler port main body 20 constitutes one member in which the main tube part 21 and the sub-tube part 22 are integrally formed through injection molding of a resin. Particularly, in the present embodiment, the fuel filler port main body 20 is formed of a non-conductive resin.

On the outer circumferential surface on an outlet opening side (on the far-right side in FIG. 2), the main tube part 21 includes an exterior part 21a to which the filler pipe 13 (illustrated in FIG. 1) is externally attached. An end part of the filler pipe 13 is externally attached to the exterior part 21a of the main tube part 21 in a state of having an increased diameter. On the outer circumferential surface on the opening side opposite to a connection side with respect to the main tube part 21, the sub-tube part 22 includes an exterior part 22a to which the breather pipe 14c (illustrated in FIG. 1) is externally attached. An end part of the breather pipe 14c is externally attached to the exterior part 22a of the sub-tube part 22 in a state of having an increased diameter.

The inlet metal fitting 30 is formed in a tubular shape and positioned at an inlet opening of the main tube part 21 of the fuel filler port main body 20 (the left front side in FIG. 2). Therefore, in the present embodiment, the inlet metal fitting 30 includes an outer tube part 31 which is disposed to face the outer circumferential surface of the main tube part 21 in a radial direction, and an inner tube part 32 which is disposed to face an inner circumferential surface of the main tube part 21 in the radial direction. A case in which the inlet metal fitting 30 is formed to have a U-shaped cross section in an axial direction having a folded portion is presented as an example, but it may be formed in a tubular shape having no folded portion. In the present embodiment, a fuel filler cap (not illustrated) is mounted at the inner tube part 32 of the inlet metal fitting 30.

The earth metal fitting 40 is formed in an elongated plate shape. The earth metal fitting 40 is positioned on the outer circumferential surface of the fuel filler port main body 20. In the present embodiment, the earth metal fitting 40 is positioned throughout the outer circumferential surface of the sub-tube part 22 from the outer circumferential surface of the main tube part 21 of the fuel filler port main body 20. In addition, the tip of the earth metal fitting 40 (the left front side in FIG. 2) is electrically connected to the inlet metal fitting 30 by coming into contact with the inlet metal fitting 30. A rear end of the earth metal fitting 40 (the far-right end in FIG. 2) is electrically connected to the breather pipe 14c by coming into contact with the breather pipe 14c.

Namely, the earth metal fitting 40 forms an earth route from the inlet metal fitting 30 toward the breather pipe 14c. The rear end of the earth metal fitting 40 may be electrically connected to the filler pipe 13 in place of the breather pipe 14c. In this case, the earth metal fitting 40 forms an earth route from the inlet metal fitting 30 toward the filler pipe 13.

3. Description of Constituent Members of Fuel Filler Port 11

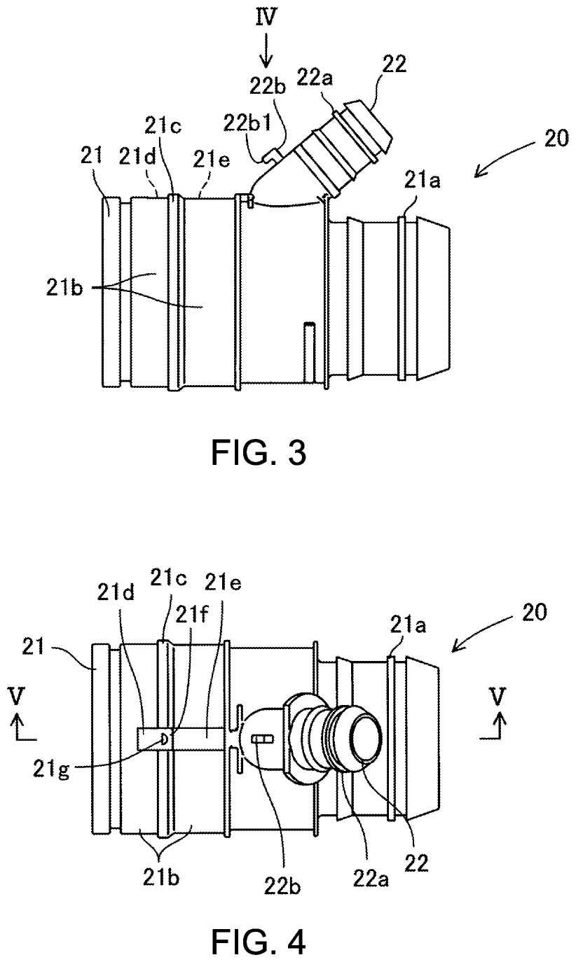

Constituent members of the fuel filler port 11, that is, each of the fuel filler port main body 20, the inlet metal fitting 30, and the earth metal fitting 40 will be described with reference to FIGS. 3 to 11.

3-1. Fuel Filler Port Main Body 20

A configuration of the fuel filler port main body 20 will be described with reference to FIGS. 3 to 8. The fuel filler port main body 20 is formed of a resin. The nozzle 2a of the fuel filler gun 2 (illustrated in FIG. 1) is inserted into the fuel filler port main body 20, and the fuel filler port main body 20 is connected to the filler pipe 13 and the breather pipe 14c. As illustrated in FIGS. 3 to 6, the fuel filler port main body 20 includes the main tube part 21 and the sub-tube part 22 which is connected to the main tube part 21.

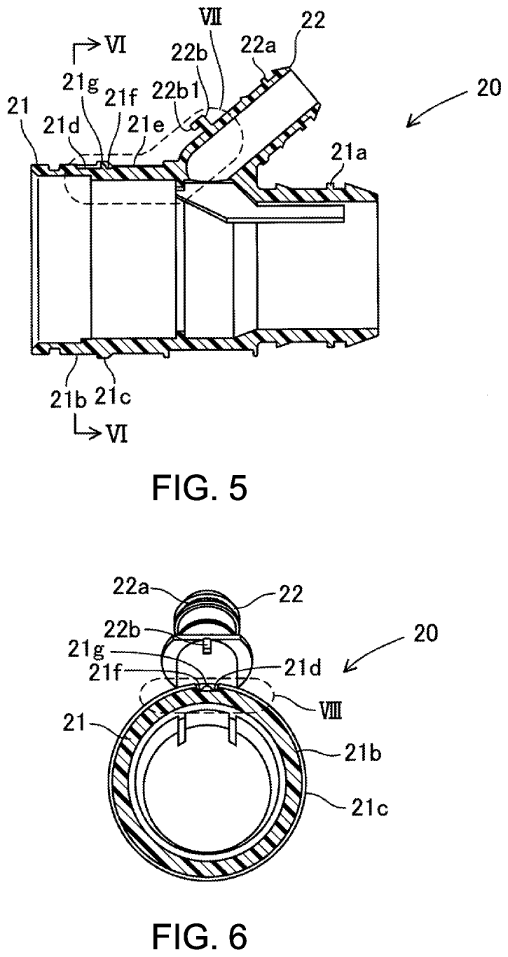

As illustrated in FIG. 5, the main tube part 21 is formed in a tubular shape having a linear central axis. The nozzle 2a (illustrated in FIG. 1) is inserted into the main tube part 21 on the inlet opening side (the left side in FIG. 3). The outlet opening side (the right side in FIG. 3) of the main tube part 21 is connected to the filler pipe 13 (illustrated in FIG. 1). As illustrated in FIGS. 3 to 5, the outer circumferential surface of the main tube part 21 on the outlet opening side includes the exterior part 21a to which the filler pipe 13 is externally attached. The exterior part 21a of the main tube part 21 is externally attached in a state in which the diameter of the end part of the filler pipe 13 is increased. On the outer circumferential surface of the exterior part 21a of the main tube part 21, a plurality of annular projections is formed at different positions in the axial direction to secure a sufficient binding force with respect to the filler pipe 13.

As illustrated in FIGS. 3 to 8, on the outer circumferential surface on the inlet opening side, the main tube part 21 further includes an arc surface main body 21b serving as a first arc surface and a circumferential projection 21c serving as a second arc surface. The arc surface main body 21b serving as a first arc surface constitutes a great part of the outer circumferential surface of the main tube part 21 on the inlet opening side and is formed in a cylindrical outer circumferential surface shape. However, as illustrated in FIGS. 6 and 8, the arc surface main body 21b is not formed over the whole circumference in a circumferential direction and has a portion in which the arc surface main body 21b is not formed in a portion in the circumferential direction (in the present embodiment, one place on an upper surface in FIG. 6).

The circumferential projection 21c serving as a second arc surface protrudes radially outward beyond the arc surface main body 21b and extends in the circumferential direction. As illustrated in FIGS. 6 and 8, similar to the arc surface main body 21b, the circumferential projection 21c is not formed over the whole circumference in the circumferential direction and has a portion in which the circumferential projection 21c is not formed in a portion in the circumferential direction (in the present embodiment, one place on an upper surface in FIG. 6).

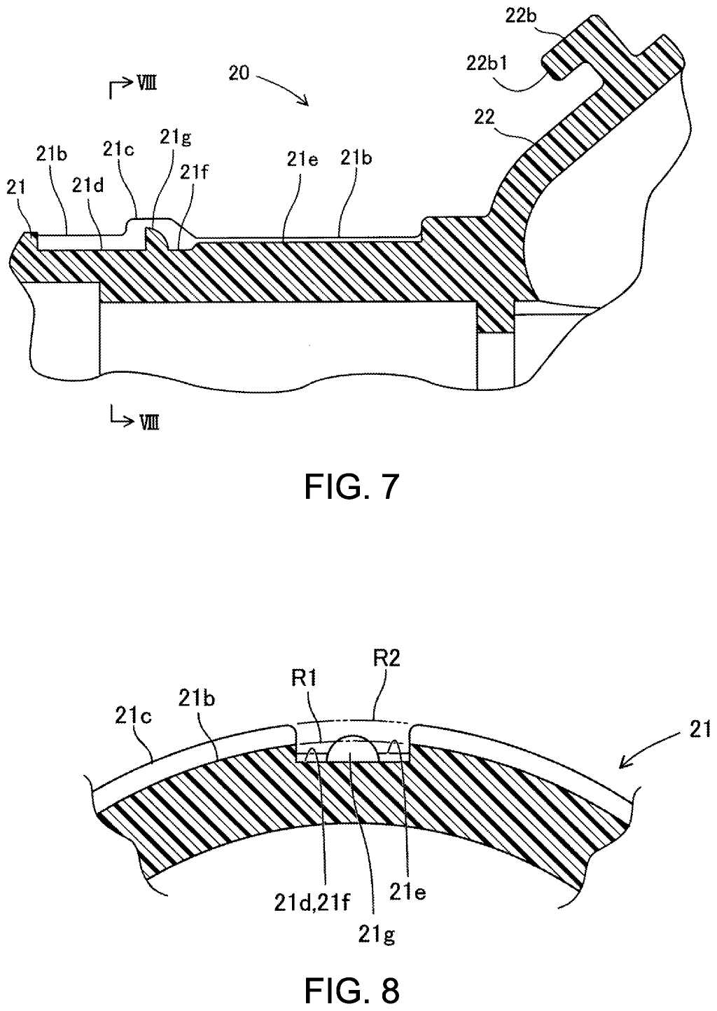

Namely, as illustrated in FIGS. 4 to 8, on the outer circumferential surface on the inlet opening side, the main tube part 21 includes an inlet side non-arc surface 21d, an outlet side non-arc surface 21e, and a projection position non-arc surface 21f which are formed to have curvatures different from those of the arc surfaces 21b and 21c at the remaining part other than the arc surfaces 21b and 21c in the circumferential direction. The inlet side non-arc surface 21d is a portion formed at a position in the arc surface main body 21b on the inlet opening side (the left side in FIG. 3) from the circumferential projection 21c in the axial direction of the main tube part 21. As illustrated in FIGS. 7 and 8, the inlet side non-arc surface 21d is located radially inside a first virtual arc surface R1 having the same diameter as the arc surface main body 21b. For example, the inlet side non-arc surface 21d is a recessed groove extending in the axial direction of the main tube part 21 and has a groove bottom surface having a flat surface shape.

The outlet side non-arc surface 21e is a portion formed at a position in the arc surface main body 21b on the outlet opening side (the right side in FIG. 3) from the circumferential projection 21c in the axial direction of the main tube part 21. As illustrated in FIGS. 7 and 8, the outlet side non-arc surface 21e is located radially inside the first virtual arc surface R1 having the same diameter as the arc surface main body 21b. For example, the outlet side non-arc surface 21e is a recessed groove extending in the axial direction of the main tube part 21 and has a groove bottom surface having a flat surface shape. In addition, the outlet side non-arc surface 21e is located at the same position as the inlet side non-arc surface 21d in the circumferential direction of the main tube part 21. In the present embodiment, the outlet side non-arc surface 21e has a slightly higher height with respect to the inlet side non-arc surface 21d but may be formed in the same flat surface shape.

The projection position non-arc surface 21f is a portion formed at a position in the circumferential projection 21c in the axial direction of the main tube part 21. Therefore, the projection position non-arc surface 21f is formed between the inlet side non-arc surface 21d and the outlet side non-arc surface 21e. As illustrated in FIGS. 7 and 8, the projection position non-arc surface 21f is located radially inside a second virtual arc surface R2 having the same diameter as the circumferential projection 21c. Moreover, the projection position non-arc surface 21f is located radially inside the first virtual arc surface R1 having the same diameter as the arc surface main body 21b. The projection position non-arc surface 21f is a recessed groove extending in the axial direction of the main tube part 21 and has a groove bottom surface having a flat surface shape. The projection position non-arc surface 21f connects the inlet side non-arc surface 21d and the outlet side non-arc surface 21e to each other in the axial direction. Namely, the projection position non-arc surface 21f is located at the same position as the inlet side non-arc surface 21d and the outlet side non-arc surface 21e in the circumferential direction of the main tube part 21. In the present embodiment, the groove bottom surface of the projection position non-arc surface 21f is formed on the same plane as the groove bottom surface of the inlet side non-arc surface 21d.

As illustrated in FIGS. 7 and 8, on the outer circumferential surface, the main tube part 21 further includes a first interlock part 21g which is configured such that the earth metal fitting 40 is interlocked therewith. The first interlock part 21g is formed on the projection position non-arc surface 21f. Specifically, the first interlock part 21g is provided to protrude radially outward from a central part of the width in the circumferential direction in the projection position non-arc surface 21f. In the first interlock part 21g, a surface of the main tube part 21 on the inlet opening side is formed in a flat surface shape orthogonal to the axial direction of the main tube part 21, and a surface of the main tube part 21 on the outlet opening side is formed in a spherical convex shape. Namely, as illustrated in FIG. 7, the first interlock part 21g is located at the same position as the circumferential projection 21c in the axial direction of the main tube part 21. Further, as illustrated in FIGS. 7 and 8, the first interlock part 21g is located in a region radially inside the second virtual arc surface R2 having the same diameter as the circumferential projection 21c. The first interlock part 21g protrudes radially outward beyond the first virtual arc surface R1 having the same diameter as the arc surface main body 21b.

As illustrated in FIGS. 3 to 6, the sub-tube part 22 is formed in a tubular shape, and one end thereof is connected to an intermediate position in the axial direction of the main tube part 21. In the present embodiment, as illustrated in FIG. 5, the sub-tube part 22 is formed in a tubular shape having a linear central axis. However, for example, the sub-tube part 22 may be formed in an L-shaped tubular shape. In addition, in the present embodiment, the sub-tube part 22 is connected to the main tube part 21 such that the axial direction thereof becomes a direction which inclines with respect to the axial direction of the main tube part 21. An angle formed by the outer circumferential surface of the main tube part 21 and a surface of the fuel filler port main body 20 on the inlet opening side in the sub-tube part 22 becomes an obtuse angle.

In addition, as illustrated in FIGS. 3 and 5, on the outer circumferential surface on the other end side, the sub-tube part 22 includes the exterior part 22a to which the breather pipe 14c (illustrated in FIG. 1) is externally attached. Particularly, the end part of the breather pipe 14c is externally attached to the outer circumferential surface of the exterior part 22a of the sub-tube part 22 in a state of having an increased diameter. On the outer circumferential surface of the exterior part 22a of the sub-tube part 22, a plurality of annular projections is formed at different positions in the axial direction to secure a sufficient binding force with respect to the breather pipe 14c.

Moreover, as illustrated in FIG. 7, on the outer circumferential surface, the sub-tube part 22 includes a second interlock part 22b. The second interlock part 22b is provided to protrude radially outward from the outer circumferential surface of the sub-tube part 22. The second interlock part 22b is provided at a different position from the first interlock part 21g. The second interlock part 22b includes a second claw 22b1 at a tip thereof. For example, the second interlock part 22b is formed in a shape protruding in a reversed L-shape. Further, the second claw 22b1 in the second interlock part 22b is formed to face the main tube part 21 side. However, the second claw 22b1 may be formed to face a side opposite to the main tube part 21 or may be formed to face the sub-tube part 22 in the circumferential direction.

3-2. Inlet Metal Fitting 30

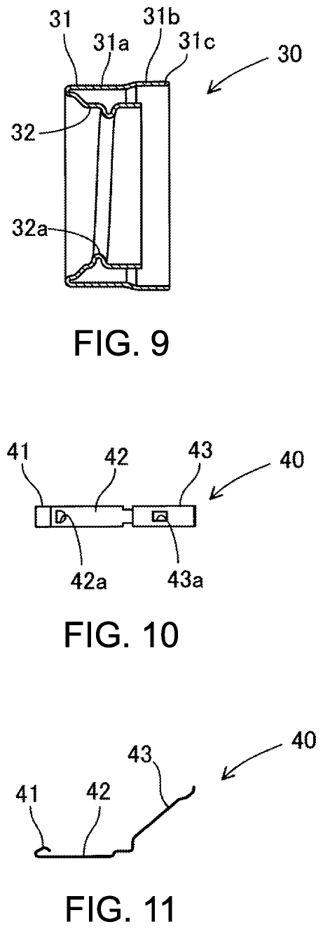

A configuration of the inlet metal fitting 30 will be described with reference to FIG. 9. The inlet metal fitting 30 is formed of a metal in a tubular shape. The inlet metal fitting 30 is formed to have a U-shaped cross section in the axial direction by being folded in the axial direction. Namely, the inlet metal fitting 30 includes the outer tube part 31 and the inner tube part 32. The outer tube part 31 includes a small diameter tube part 31a, a large diameter tube part 31b, and a caulking part 31c from the inlet opening side toward the outlet opening of the main tube part 21.

The small diameter tube part 31a of the outer tube part 31 is formed in a cylindrical shape, and the large diameter tube part 31b is formed in a cylindrical shape having a larger diameter than the small diameter tube part 31a. Specifically, an inner diameter of the small diameter tube part 31a is larger than an outer diameter of the arc surface main body 21b of the main tube part 21 and is smaller than an outer diameter of the circumferential projection 21c. An inner diameter of the large diameter tube part 31b is larger than the outer diameter of the circumferential projection 21c.

The caulking part 31c (which will be described below) is a portion deformed through caulking. The caulking part 31c is formed at the end part of the main tube part 21 on the outlet opening side in the outer tube part 31. In a state before caulking, the caulking part 31c is formed to have the same diameter as the large diameter tube part 31b. Namely, an inner diameter of the caulking part 31c before caulking is larger than the outer diameter of the circumferential projection 21c of the main tube part 21. Since the inner diameter of the caulking part 31c after caulking is smaller than the outer diameter of the circumferential projection 21c of the main tube part 21, the caulking part 31c after caulking is interlocked with the circumferential projection 21c in the axial direction of the main tube part 21.

The inner tube part 32 is a portion which is formed by being folded radially inward from the end part of the outer tube part 31 on the inlet opening side. The inner tube part 32 has a female screw 32a and is screwed to the fuel filler cap (not illustrated).

3-3. Earth Metal Fitting 40

A configuration of the earth metal fitting 40 will be described with reference to FIGS. 10 and 11. The earth metal fitting 40 is formed of a metal in an elongated plate shape. Regarding the earth metal fitting 40, a metal exhibiting an elastic force is applied thereto. For example, a spring steel is preferably used, but other metal materials may be applied thereto. The earth metal fitting 40 includes a tip bent part 41, a connection extension part 42, and a pipe abutment part 43 from an elongated end part.

The tip bent part 41 is located at a tip (the left end in FIG. 10) in an elongated direction. The tip bent part 41 is formed such that it can be elastically deformed in the vertical direction in FIG. 11, that is, the radial direction of the main tube part 21 of the fuel filler port main body 20 (illustrated in FIG. 3). For example, the tip bent part 41 is formed to have a U-shaped cross section in the axial direction. Namely, in the tip bent part 41, the folded portion having a U-shape is formed such that it can be elastically deformed in the radial direction of the main tube part 21. In addition, in the present embodiment, the end thereof is located on a side above in FIG. 11, that is, radially outside the main tube part 21 of the fuel filler port main body 20 (illustrated in FIG. 3).

The connection extension part 42 is formed in an elongated flat plate shape. The connection extension part 42 is connected to the tip bent part 41. In the present embodiment, the connection extension part 42 is connected to an end of a lower part in FIG. 11 in the tip bent part 41. In the present embodiment, the connection extension part 42 is formed in the same flat surface shape as the lower part in FIG. 11 in the tip bent part 41. Moreover, the connection extension part 42 includes a first interlocked part 42a (a penetration hole). The first interlocked part 42a is formed in a central part of the connection extension part 42 in a width direction. The penetration hole serving as the first interlocked part 42a is configured to allow the first interlock part 21g of the main tube part 21 to be inserted therethrough. Further, the first interlocked part 42a is interlocked with the first interlock part 21g of the main tube part 21. In addition, the first interlocked part 42a is formed in a shape corresponding to the first interlock part 21g of the main tube part 21, that is, a semicircular shape.

The pipe abutment part 43 is formed in an elongated plate shape and is connected to an end of the connection extension part 42. In the present embodiment, since the pipe abutment part 43 is formed along the outer circumferential surface of the sub-tube part 22, the pipe abutment part 43 is formed to be bent upward in FIG. 11 from the end of the connection extension part 42. The pipe abutment part 43 is a portion abutting the breather pipe 14c. In addition, the pipe abutment part 43 includes a second interlocked part 43a (penetration hole). The second interlocked part 43a is formed in a central part of the pipe abutment part 43 in the width direction. Namely, the second interlocked part 43a is formed at a different position from the first interlocked part 42a in a longitudinal direction of the earth metal fitting 40. Further, the penetration hole serving as the second interlocked part 43a is configured to allow the second interlock part 22b of the sub-tube part 22 to be inserted therethrough. The second interlocked part 43a is interlocked with the second interlock part 22b of the sub-tube part 22. In addition, the second interlocked part 43a is formed in a shape corresponding to the second interlock part 22b of the sub-tube part 22.

4. Method of Manufacturing Fuel Filler Port 11 and Configuration of Fuel Filler Port 11 after being Assembled

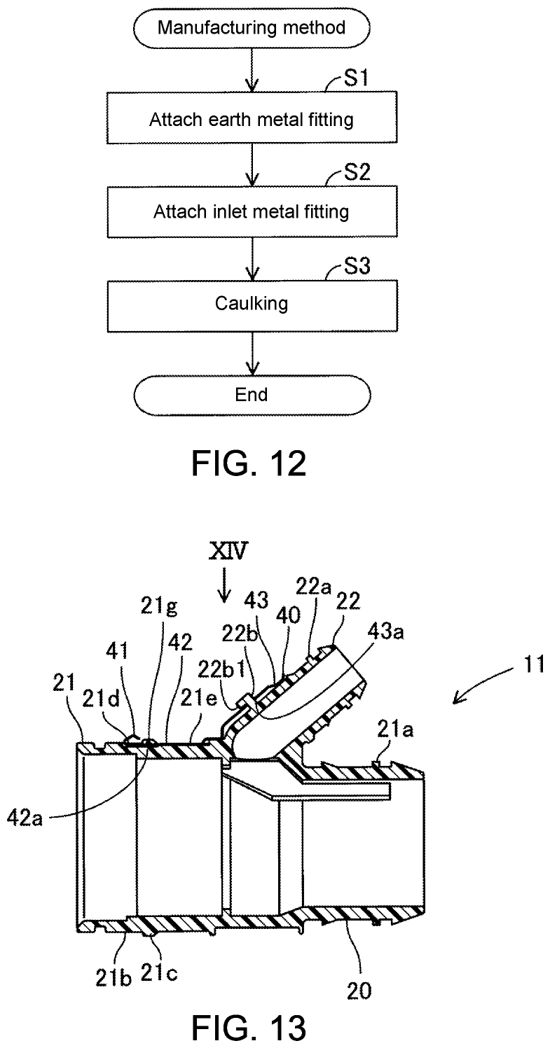

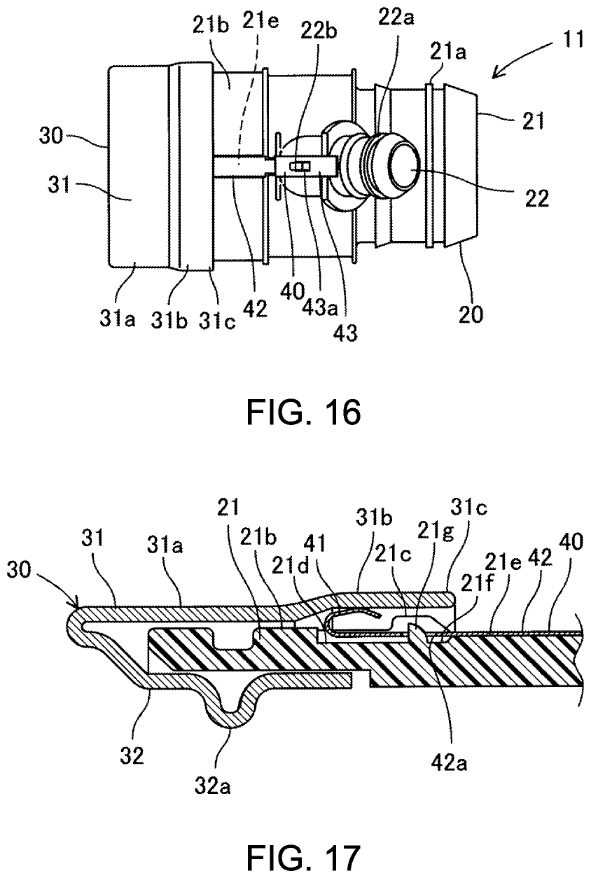

A method of manufacturing the fuel filler port 11 will be described with reference to FIGS. 7, 8, and 12 to 21. As illustrated in FIG. 12, in the fuel filler port 11, the earth metal fitting 40 is attached to the fuel filler port main body 20 (S1, a positioning step and an earth metal fitting attaching step). Subsequently, the inlet metal fitting 30 is attached to the fuel filler port main body 20 (S2, the positioning step and an inlet metal fitting attaching step). In this manner, through Steps S1 and S2, the inlet metal fitting 30 and the earth metal fitting 40 are positioned in the fuel filler port main body 20.

Subsequently, caulking of the caulking part 31c of the inlet metal fitting 30 is performed (S3, a caulking step). Accordingly, the inlet metal fitting 30 is interlocked with the fuel filler port main body 20, and the earth metal fitting 40 is fixed to the fuel filler port main body 20 and the inlet metal fitting 30. Hereinafter, the method of manufacturing the fuel filler port 11 will be described in detail.

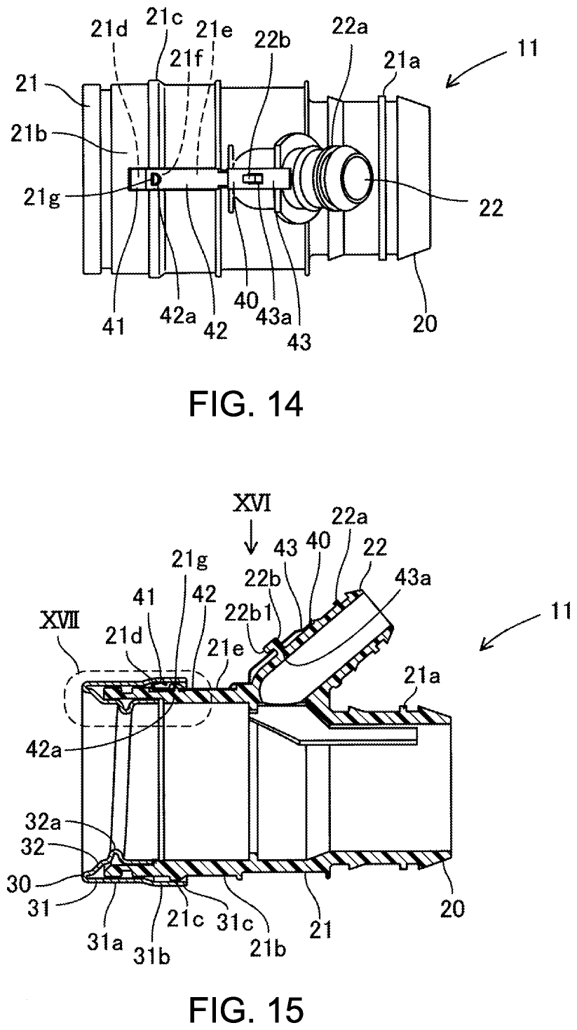

First, as illustrated in FIGS. 13 and 14, the earth metal fitting 40 is positioned in the fuel filler port main body 20 (S1 in FIG. 12). Specifically, on the outer circumferential surface of the fuel filler port main body 20, the earth metal fitting 40 is disposed to extend in the axial direction of the fuel filler port main body 20. The first interlock part 21g of the main tube part 21 of the fuel filler port main body 20 and the first interlocked part 42a of the connection extension part 42 of the earth metal fitting 40 are interlocked with each other.

Specifically, the first interlock part 21g in the main tube part 21 is inserted through the penetration hole (the first interlocked part 42a of the earth metal fitting 40). Further, the first interlock part 21g is interlocked with the inner circumferential surface of the penetration hole (the first interlocked part 42a). Therefore, the connection extension part 42 of the earth metal fitting 40 is interlocked with the first interlock part 21g in the main tube part 21 in the longitudinal direction (the extending direction) of the connection extension part 42 and is interlocked therewith in the width direction (the vertical direction in FIG. 10) of the connection extension part 42. In this manner, the connection extension part 42 of the earth metal fitting 40 is positioned on the outer circumferential surface of the main tube part 21.

Moreover, the second interlock part 22b of the sub-tube part 22 of the fuel filler port main body 20 and the second interlocked part 43a of the pipe abutment part 43 of the earth metal fitting 40 are interlocked with each other. Specifically, the second interlock part 22b in the sub-tube part 22 is inserted through the penetration hole (the second interlocked part 43a of the earth metal fitting 40). Further, the second interlock part 22b is interlocked with the inner circumferential surface of the penetration hole (the second interlocked part 43a). Therefore, the pipe abutment part 43 of the earth metal fitting 40 is interlocked with the second interlock part 22b in the sub-tube part 22 in the longitudinal direction (the extending direction) of the pipe abutment part 43 and is interlocked therewith in the width direction (the vertical direction in FIG. 10) of the pipe abutment part 43.

Moreover, the second interlock part 22b of the sub-tube part 22 includes the second claw 22b1 at the tip thereof. The second claw 22b1 is interlocked with an edge of the penetration hole (the second interlocked part 43a of the pipe abutment part 43 of the earth metal fitting 40). Further, the second claw 22b1 restricts separation of the pipe abutment part 43 of the earth metal fitting 40 radially outward of the sub-tube part 22.

In this manner, in a state in which the earth metal fitting 40 is positioned in the fuel filler port main body 20, the tip bent part 41 of the earth metal fitting 40 is located on the inlet side non-arc surface 21d of the main tube part 21, and the connection extension part 42 of the earth metal fitting 40 is located on the outlet side non-arc surface 21e and the projection position non-arc surface 21f. Therefore, the connection extension part 42 is disposed to extend in the axial direction of the main tube part 21.

In addition, in a state in which the earth metal fitting 40 is positioned in the fuel filler port main body 20, the first interlock part 21g is interlocked with the penetration hole (the first interlocked part 42a of the earth metal fitting 40), and the second claw 22b1 is interlocked with the edge of the penetration hole (the second interlocked part 43a of the earth metal fitting 40). Accordingly, in a state in which the earth metal fitting 40 is assembled in the fuel filler port main body 20, falling of the earth metal fitting 40 from the fuel filler port main body 20 at the time of conveyance before the inlet metal fitting 30 is assembled, at the time of assembling the inlet metal fitting 30, or the like can be curbed.

Here, as illustrated in FIG. 8, the inlet side non-arc surface 21d is located radially inside the first virtual arc surface R1 having the same diameter as the arc surface main body 21b. The outlet side non-arc surface 21e is located radially inside the first virtual arc surface R1 having the same diameter as the arc surface main body 21b. The projection position non-arc surface 21f is located radially inside the second virtual arc surface R2 having the same diameter as the circumferential projection 21c. Moreover, the projection position non-arc surface 21f is located radially inside the first virtual arc surface R1 having the same diameter as the arc surface main body 21b.

Therefore, the U-shaped lower part in FIG. 11 in the tip bent part 41 of the earth metal fitting 40 is disposed between the inlet side non-arc surface 21d and the first virtual arc surface R1 illustrated in FIG. 8. On the other hand, the U-shaped upper part in FIG. 11 in the tip bent part 41 is located radially outside the first virtual arc surface R1 illustrated in FIG. 8. Moreover, the U-shaped upper part of the tip bent part 41 is located radially outside the second virtual arc surface R2 illustrated in FIG. 8. In this state, the tip bent part 41 is in a disposed state such that it can be elastically deformed in the radial direction of the main tube part 21.

In addition, the connection extension part 42 of the earth metal fitting 40 is disposed between the outlet side non-arc surface 21e and the first virtual arc surface R1 and between the projection position non-arc surface 21f and the first virtual arc surface R1. The connection extension part 42 may protrude radially outward beyond the first virtual arc surface R1 by a slight amount.

Subsequently, as illustrated in FIGS. 15 to 17, the inlet metal fitting 30 is positioned in the fuel filler port main body 20 (S2 in FIG. 12). As illustrated in FIGS. 15 and 17, the end part of the main tube part 21 of the fuel filler port main body 20 on the inlet opening side is located in a space between the outer tube part 31 and the inner tube part 32 of the inlet metal fitting 30 in the radial direction. Therefore, the outer tube part 31 is disposed to face the outer circumferential surface of the main tube part 21 in the radial direction, and the inner tube part 32 is disposed to face the inner circumferential surface of the main tube part 21 in the radial direction.

Further, as illustrated in FIG. 17, the caulking part 31c of the outer tube part 31 of the inlet metal fitting 30 is located at a position on the outlet opening side (the right side in FIG. 17) from the circumferential projection 21c of the main tube part 21. Therefore, as illustrated in FIG. 17, the tip bent part 41 of the earth metal fitting 40 is disposed in an elastically deformed state between the outer circumferential surface of the main tube part 21 and the inner circumferential surface of the large diameter tube part 31b of the outer tube part 31 of the inlet metal fitting 30 in the radial direction. Therefore, the tip bent part 41 is disposed in a state of having a biasing force in the radial direction with respect to the inner circumferential surface of the large diameter tube part 31b of the outer tube part 31 of the inlet metal fitting 30. Namely, the earth metal fitting 40 forms an earth route from the inlet metal fitting 30 by abutting the inlet metal fitting 30. Here, the tip bent part 41 may be in a state of abutting the inlet side non-arc surface 21d of the main tube part 21 or may be in a state of not abutting the inlet side non-arc surface 21d.

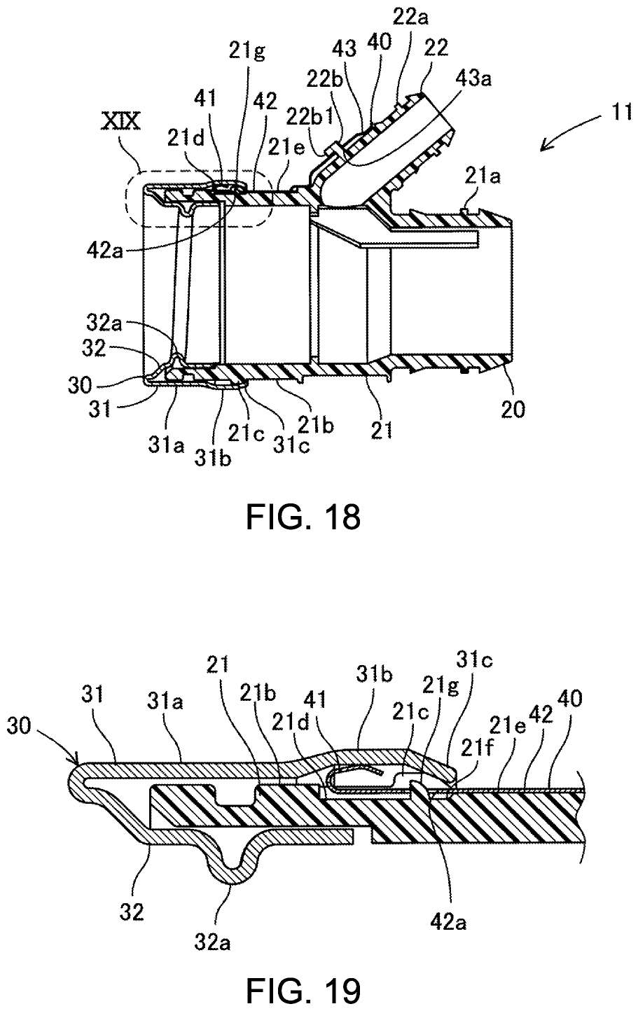

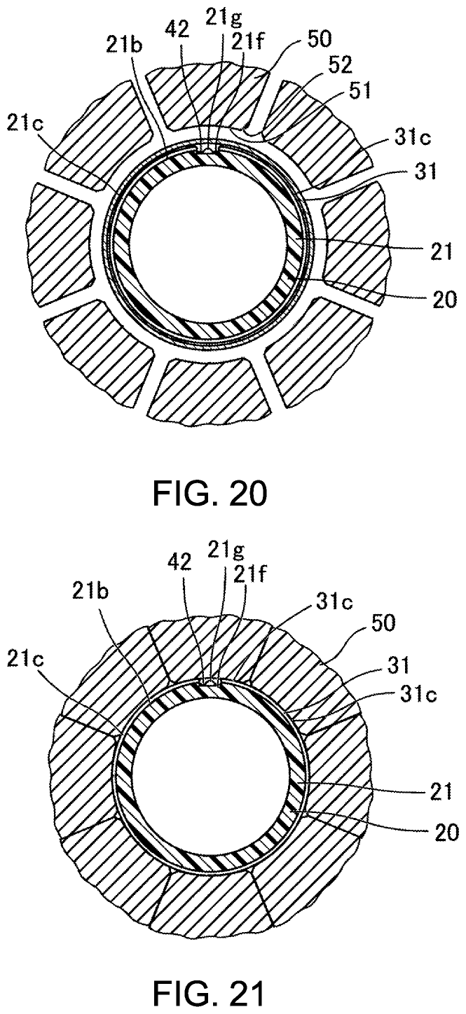

Subsequently, as illustrated in FIGS. 18 and 19, caulking processing is performed with respect to the caulking part 31c of the outer tube part 31 of the inlet metal fitting 30 (S3 in FIG. 12). The caulking part 31c of the outer tube part 31 is deformed radially inward using a caulking jig 50 (illustrated in FIGS. 20 and 21). The caulking part 31c after caulking becomes smaller than the outer diameter of the circumferential projection 21c. Therefore, the caulking part 31c is interlocked with the circumferential projection 21c in the axial direction of the main tube part 21. The caulking part 31c deformed radially inward by the caulking jig 50 may be formed intermittently in the circumferential direction in a plurality of places or may be formed continuously over the whole circumference in the circumferential direction.

A case of intermittently forming a plurality of caulking parts 31c in the circumferential direction will be described with reference to FIGS. 20 to 22. As illustrated in FIG. 20, in the caulking step S3, the outer tube part 31 of the inlet metal fitting 30 is deformed radially inward using a plurality of caulking jigs 50 divided in the circumferential direction. Specifically, each of the plurality of caulking jigs 50 includes a pressing surface 51 having an arc surface shape, and chamfered parts 52 formed in corner parts on both sides in the circumferential direction with respect to the pressing surface 51.

In the pressing surface 51 of the caulking jig 50, a portion of the outer tube part 31 in the circumferential direction is deformed along the shape of the pressing surface 51 radially inward. In the present embodiment, the total width in the circumferential direction between the pressing surface 51 of the caulking jig 50 and the pressing surface 51 of the caulking jig 50 adjacent to each other in the circumferential direction, that is, the chamfered parts 52 of the two caulking jigs 50 adjacent to each other is extremely small and is narrower than the width of the earth metal fitting 40. Therefore, a portion of the pressing surface 51 in the circumferential direction in one or two caulking jigs 50 faces the earth metal fitting 40 in the radial direction. However, the width of the chamfered part 52 can be arbitrarily set.

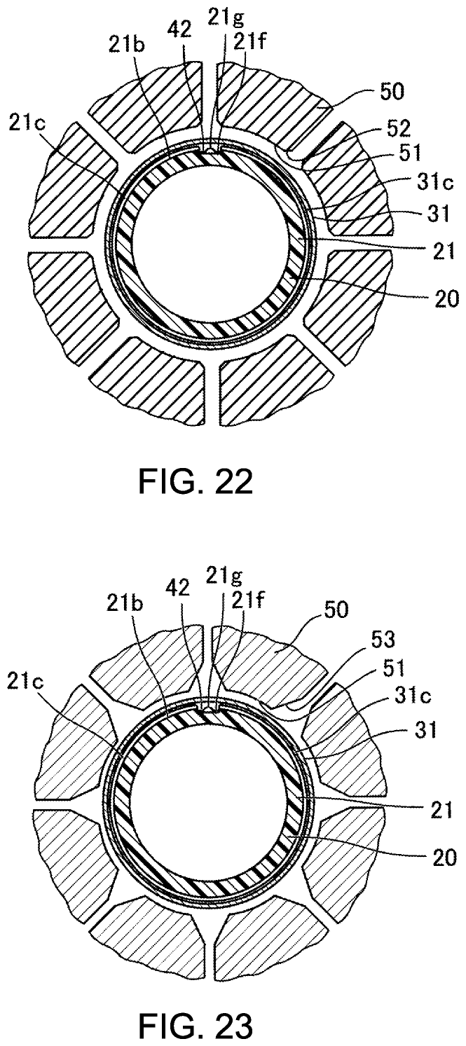

In FIG. 20, a state in which a portion of the pressing surface 51 at the center in the circumferential direction in one caulking jig 50 faces the overall width of the earth metal fitting 40 in the circumferential direction in the radial direction is illustrated. However, as illustrated in FIG. 22, a state in which a boundary portion between the caulking jigs 50 adjacent to each other in the circumferential direction, that is, the chamfered parts 52 of one or two caulking jigs 50 faces only a portion of the earth metal fitting 40 in the circumferential direction in the radial direction may be adopted. In this case, a portion of the pressing surface 51 of the caulking jig 50 in the circumferential direction is in a state of facing the remaining part of the earth metal fitting 40 in the circumferential direction in the radial direction. In other words, there is no need for the position of the caulking jig 50 in the circumferential direction to be particularly stipulated with respect to the fuel filler port 11.

Further, as illustrated in FIG. 21, the plurality of caulking jigs 50 is moved radially inward. Consequently, in the outer tube part 31 of the inlet metal fitting 30, a portion pressed to the pressing surface 51 of the caulking jig 50 is significantly deformed radially inward along the pressing surface 51. On the other hand, in the outer tube part 31 of the inlet metal fitting 30, portions corresponding to the chamfered parts 52 of the caulking jigs 50 are slightly deformed radially inward.

Namely, the outer tube part 31 of the inlet metal fitting 30 includes a plurality of caulking parts 31c and 31c which is intermittently disposed in the circumferential direction. Further, at least a portion of the earth metal fitting 40 in the circumferential direction faces the caulking part 31c in the radial direction. In FIG. 21, the overall width of the earth metal fitting 40 in the circumferential direction faces the caulking part 31c in the radial direction. However, as illustrated in FIG. 22, when the caulking jig 50 is disposed, only a portion of the earth metal fitting 40 in the width direction (the circumferential direction of the main tube part 21) faces the caulking part 31c in the radial direction of the main tube part 21, and the remaining part of the earth metal fitting 40 in the width direction faces an area between the caulking part 31c and the caulking part 31c adjacent to each other in the circumferential direction in the radial direction of the main tube part 21.

Further, the caulking part 31c is interlocked with the circumferential projection 21c in the axial direction of the main tube part 21. In this manner, the inlet metal fitting 30 is interlocked with the fuel filler port main body 20. When the caulking part 31c is formed over the whole circumference in the circumferential direction, the caulking part 31c is in a state of being interlocked therewith in the axial direction of the main tube part 21 throughout the whole circumference of the circumferential projection 21c.

As described above, by bending and forming the tip bent part 41 of the earth metal fitting 40, a configuration having a biasing force in the radial direction is realized. Further, the tip bent part 41 of the earth metal fitting 40 is disposed between the outer circumferential surface of the main tube part 21 and the inner circumferential surface of the large diameter tube part 31b of the outer tube part 31 of the inlet metal fitting 30 in the radial direction in a state of having a biasing force with respect to the inner circumferential surface of the large diameter tube part 31b of the outer tube part 31 of the inlet metal fitting 30. Therefore, the tip bent part 41 of the earth metal fitting 40 maintains a state of always abutting the outer tube part 31 of the inlet metal fitting 30 due to a biasing force. Namely, an earth route from the inlet metal fitting 30 toward the earth metal fitting 40 is reliably secured. In addition, since the fuel filler port 11 has a configuration using the earth metal fitting 40, there is no need for the fuel filler port main body 20 to have a configuration of forming a conductive layer by performing two-color forming. Therefore, cost reduction of the fuel filler port 11 can be achieved.

In addition, the inlet metal fitting 30 is interlocked with the circumferential projection 21c of the main tube part 21 in the axial direction by deforming the caulking part 31c of the outer tube part 31 radially inward, that is, by performing caulking. In this manner, in the fuel filler port 11, the structure thereof has a simple configuration by employing a caulking structure, and therefore cost reduction can be achieved.

Moreover, when caulking of the caulking part 31c using the caulking jig 50 is performed, there is a likelihood that the caulking part 31c will apply a pressing force to the connection extension part 42 of the earth metal fitting 40. However, as described above, the connection extension part 42 of the earth metal fitting 40 is disposed on the outlet side non-arc surface 21e and the projection position non-arc surface 21f. Therefore, the connection extension part 42 does not protrude radially outward beyond the first virtual arc surface R1 having the same diameter as the arc surface main body 21b of the main tube part 21, or the amount of protrusion is extremely small even if it protrudes. For this reason, the caulking part 31c when the caulking processing is performed does not apply an intensive pressing force to the connection extension part 42. For instance, when the connection extension part 42 of the earth metal fitting 40 receives an intensive pressing force, it may cause deterioration in durability depending on the plate thickness of the connection extension part 42. However, as described above, deterioration in durability of the earth metal fitting 40 can be prevented.

In addition, the tip bent part 41 of the earth metal fitting 40 has a U-shaped cross section in the axial direction, and a free end side of the tip bent part 41 is caused to abut the inner circumferential surface of the outer tube part 31 of the inlet metal fitting 30. Due to this configuration, a fulcrum position of elastic deformation in the tip bent part 41 can be made stable, and a biasing force with respect to the inlet metal fitting 30 can be made stable.

### Embodiment 2

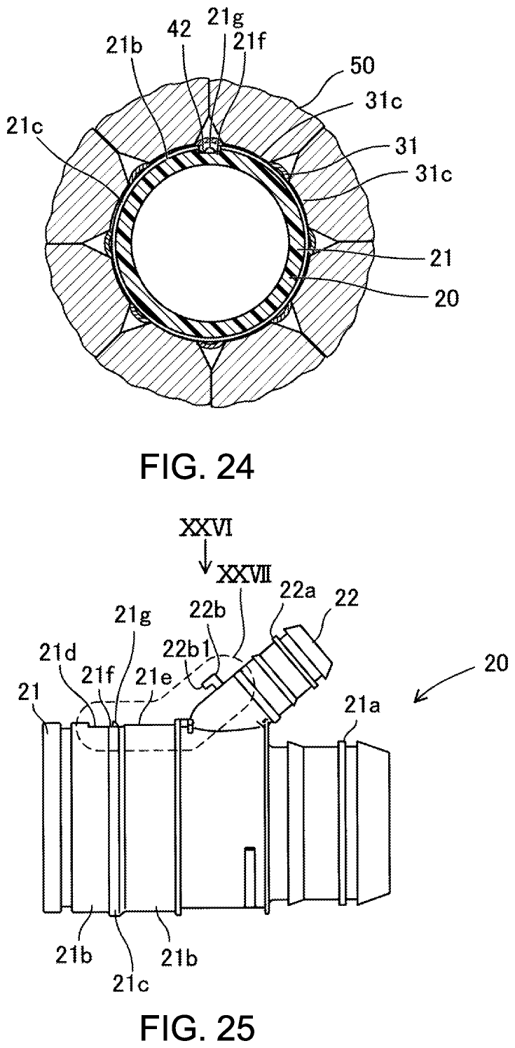

The fuel filler port 11 according to Embodiment 2 and the method of manufacturing the same will be described with reference to FIGS. 23 and 24. In the foregoing fuel filler port 11 according to Embodiment 1, at least a portion of the earth metal fitting 40 in the circumferential direction is caused to face the caulking part 31c of the outer tube part 31 of the inlet metal fitting 30 in the radial direction.

In Embodiment 2, the earth metal fitting 40 is disposed in a gap in the circumferential direction between the caulking part 31c and the caulking part 31c adjacent to each other in the circumferential direction. Namely, only a portion of the outer tube part 31 of the inlet metal fitting 30 in the circumferential direction is deformed and is interlocked with a portion of the circumferential projection 21c of the main tube part 21 in the circumferential direction in the axial direction. As illustrated in FIG. 23, in the caulking step, a portion of the outer tube part 31 of the inlet metal fitting 30 in the circumferential direction is deformed radially inward using a plurality of caulking jigs 50 divided in the circumferential direction. An area (an escape part 53) between the pressing surface 51 of the caulking jig 50 and the pressing surface 51 of the caulking jig 50 adjacent to each other in the circumferential direction becomes a portion which does not abut the outer tube part 31 of the inlet metal fitting 30.

Therefore, as illustrated in FIG. 24, the caulking jig 50 is moved radially inward, and a portion of the outer tube part 31 in the circumferential direction is deformed radially inward. Consequently, in the outer tube part 31 of the inlet metal fitting 30, a portion pressed to the pressing surface 51 of the caulking jig 50 is deformed radially inward. Namely, the outer tube part 31 of the inlet metal fitting 30 includes a plurality of caulking parts 31c and 31c intermittently disposed in the circumferential direction. On the other hand, in the outer tube part 31 of the inlet metal fitting 30, a portion which is not pressed to the pressing surface 51 of the caulking jig 50, that is, a portion facing the escape part 53 is deformed to an extent that it is pulled to a portion deformed by the pressing surface 51. Namely, the amount of deformation in a portion which is not pressed to the caulking jig 50 is smaller than that in a portion which is pressed to the pressing surface 51 of the caulking jig 50.

Further, the earth metal fitting 40 is disposed in the gap in the circumferential direction between the caulking part 31c and the caulking part 31c adjacent to each other in the circumferential direction. Namely, the earth metal fitting 40 is located in a portion which is not pressed by the caulking jig 50. A situation in which the caulking part 31c when the caulking processing is performed applies a pressing force to the connection extension part 42 of the earth metal fitting 40 can be more reliably curbed. Therefore, deterioration in durability of the earth metal fitting 40 can be prevented.

### Embodiment 3

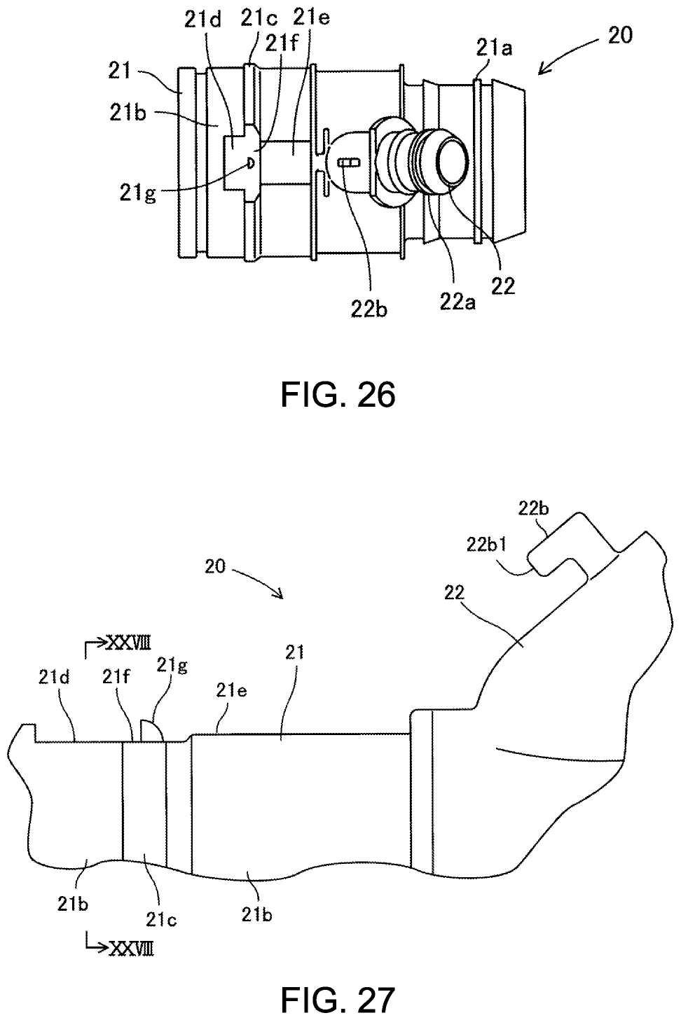

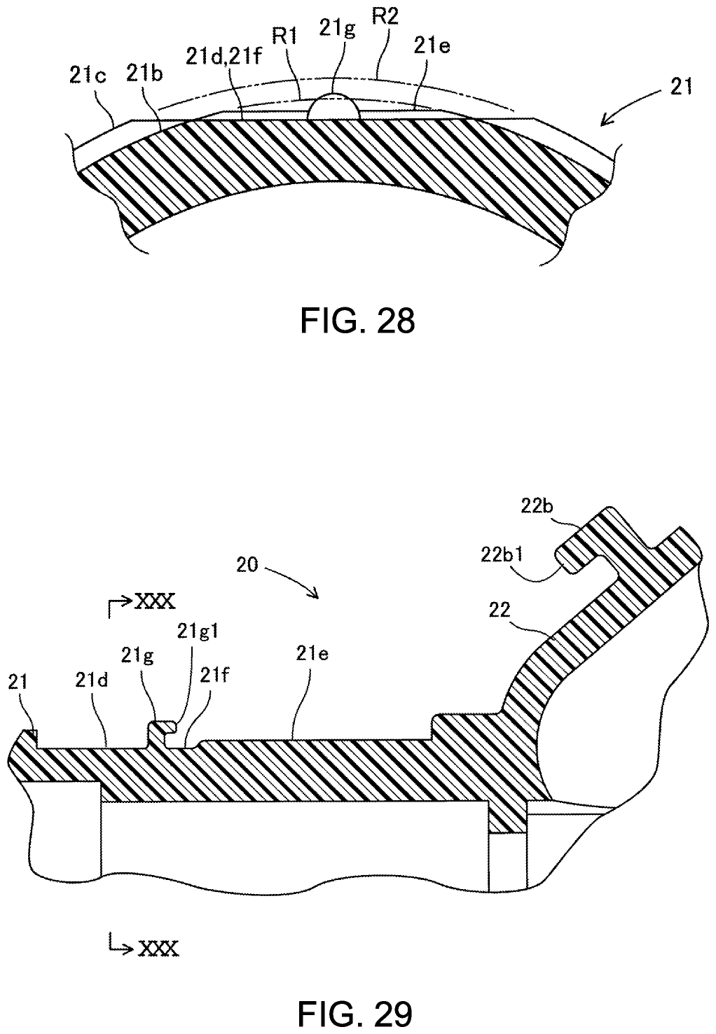

The fuel filler port 11 according to Embodiment 3 will be described with reference to FIGS. 25 to 28. In the main tube part 21 of the fuel filler port main body 20 constituting the fuel filler port 11 according to Embodiment 1, the inlet side non-arc surface 21d, the outlet side non-arc surface 21e, and the projection position non-arc surface 21f are formed in a recessed groove shape. In contrast, in the fuel filler port 11 according to Embodiment 3, the inlet side non-arc surface 21d, the outlet side non-arc surface 21e, and the projection position non-arc surface 21f are formed have a simple flat surface shape instead of a recessed groove shape. Accordingly, a die for forming the fuel filler port main body 20 can have a simple configuration without causing the parts of the inlet side non-arc surface 21d, the outlet side non-arc surface 21e, and the projection position non-arc surface 21f in an under-cut shape. Therefore, manufacturing costs of the fuel filler port main body 20 can be reduced.

### Embodiment 4

The fuel filler port 11 according to Embodiment 4 will be described with reference to FIGS. 29 to 32. The fuel filler port main body 20 constituting the fuel filler port 11 according to Embodiment 4 differs from the fuel filler port main body 20 according to Embodiment 3 in the first interlock part 21g. Moreover, the earth metal fitting 40 constituting the fuel filler port 11 according to Embodiment 4 differs the earth metal fitting 40 of Embodiment 3 in the first interlocked part 42a. The configuration is otherwise similar thereto.

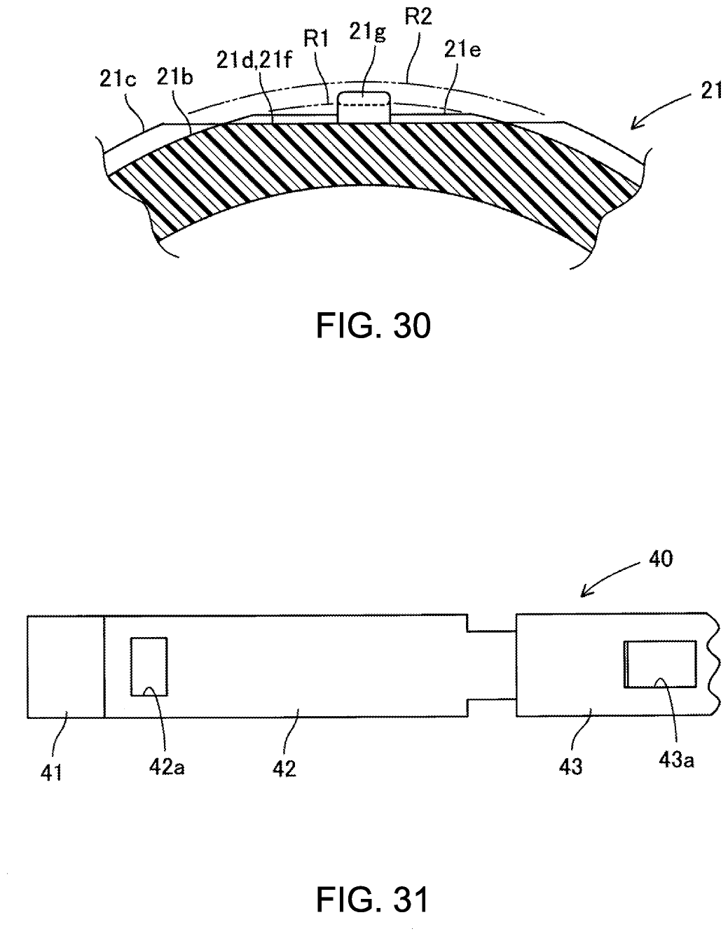

As illustrated in FIGS. 29 and 30, the first interlock part 21g is formed on the projection position non-arc surface 21f of the outer circumferential surface of the main tube part 21 and is provided to protrude radially outward from the projection position non-arc surface 21f. The first interlock part 21g includes a first claw 21g1 at a tip thereof. For example, the first interlock part 21g is formed in a shape protruding in a reversed L-shape. Further, the first claw 21g1 in the first interlock part 21g is formed to face the outlet side (the right side in FIG. 29) of the main tube part 21.

Here, the second claw 22b1 of the second interlock part 22b of the sub-tube part 22 is formed to face the main tube part 21 side. Therefore, the first claw 21g1 of the first interlock part 21g and the second claw 22b1 of the second interlock part 22b are configured to protrude in a direction in which they face each other, that is, in a direction in which they face each other in the longitudinal direction of the earth metal fitting 40.

However, the first claw 21g1 of the first interlock part 21g may be formed to face the inlet side (the left side in FIG. 29) of the main tube part 21. In this case, the second claw 22b1 of the second interlock part 22b may be formed to face a side opposite to the main tube part 21 (the right side in FIG. 29) in the sub-tube part 22. In this case, the first claw 21g1 of the first interlock part 21g and the second claw 22b1 of the second interlock part 22b are configured to protrude in a direction in which they oppose to each other, that is, in a direction in which they oppose to each other in the longitudinal direction of the earth metal fitting 40. In addition to those described above, the first claw 21g1 of the first interlock part 21g may be formed to face the main tube part 21 in the circumferential direction.

Moreover, as illustrated in FIG. 30, the first interlock part 21g is located in a region radially inside the second virtual arc surface R2 having the same diameter as the circumferential projection 21c of the main tube part 21. The first interlock part 21g protrudes radially outward beyond the first virtual arc surface R1 having the same diameter as the arc surface main body 21b.

As illustrated in FIG. 31, the penetration hole (the first interlocked part 42a of the earth metal fitting 40) is formed in a rectangular shape. The penetration hole (the first interlocked part 42a) is configured to allow the first interlock part 21g to be inserted therethrough. The first interlocked part 42a is interlocked with the first interlock part 21g. The penetration hole (the first interlocked part 42a) is not limited to a rectangular shape and need only be formed to allow the first interlock part 21g to be inserted therethrough.

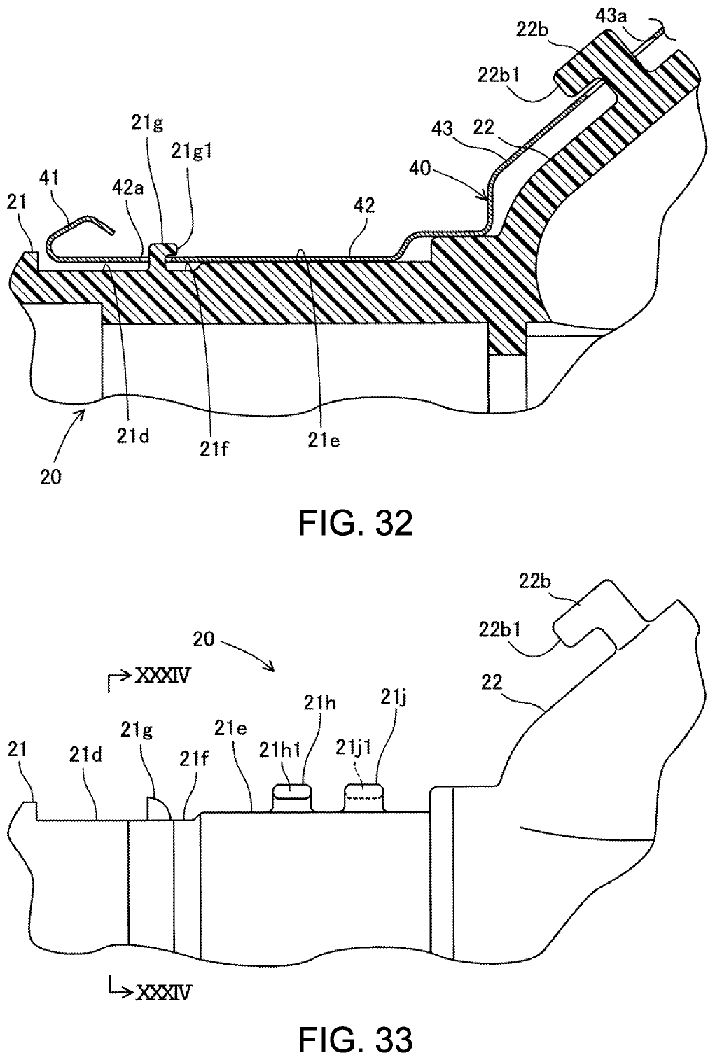

As illustrated in FIG. 32, the earth metal fitting 40 is positioned in the fuel filler port main body 20. Specifically, the first interlock part 21g in the main tube part 21 is inserted through the penetration hole (the first interlocked part 42a of the earth metal fitting 40). Further, the first interlock part 21g is interlocked with the inner circumferential surface of the penetration hole (the first interlocked part 42a). Moreover, the first claw 21g1 of the first interlock part 21g is interlocked with the edge of the penetration hole (the first interlocked part 42a of the earth metal fitting 40). Therefore, the first claw 21g1 restricts separation of the connection extension part 42 of the earth metal fitting 40 radially outward of the main tube part 21.

In addition, similar to Embodiments 1 and 3, the second interlock part 22b in the sub-tube part 22 is inserted through the penetration hole (the second interlocked part 43a of the earth metal fitting 40). Further, the second claw 22b1 of the second interlock part 22b is interlocked with the edge of the penetration hole (the second interlocked part 43a of the earth metal fitting 40). Therefore, separation of the pipe abutment part 43 of the earth metal fitting 40 radially outward of the sub-tube part 22 is restricted.

Here, the first claw 21g1 of the first interlock part 21g and the second claw 22b1 of the second interlock part 22b protrude in a direction in which they face each other. Therefore, when the earth metal fitting 40 is assembled in the fuel filler port main body 20, assembling is performed in a direction in which the penetration hole (the first interlocked part 42a) and the penetration hole (the second interlocked part 43a) in the earth metal fitting 40 approach each other while the earth metal fitting 40 is elastically deformed. Therefore, in a state in which the earth metal fitting 40 is assembled in the fuel filler port main body 20, falling of the earth metal fitting 40 from the fuel filler port main body 20 can be curbed. Particularly, since the earth metal fitting 40 does not fall from the fuel filler port main body 20 unless the earth metal fitting 40 is elastically deformed, a high effect of curbing falling is exhibited.

When the earth metal fitting 40 is assembled in the fuel filler port main body 20, elastic deformation in a direction in which the penetration hole (the first interlocked part 42a) and the penetration hole (the second interlocked part 43a) in the earth metal fitting 40 approach each other can be comparatively easily performed. Therefore, assemblability of the earth metal fitting 40 can be made satisfactory.

In Embodiment 4, the first claw 21g1 of the first interlock part 21g and the second claw 22b1 of the second interlock part 22b are caused to protrude in a direction in which they face each other but may be caused to protrude in a direction in which they oppose each other. In this case as well, falling of the earth metal fitting 40 from the fuel filler port main body 20 can be curbed.

In addition, in the foregoing description, the earth metal fitting 40 is assembled in the fuel filler port main body 20 while the earth metal fitting 40 is elastically deformed. Furthermore, the first interlock part 21g may be caused to be elastically deformed. Namely, the first interlock part 21g employs a snap-fit structure. Accordingly, assemblability of the earth metal fitting 40 can be made more satisfactory and falling of the earth metal fitting 40 from the fuel filler port main body 20 can be curbed more effectively. In this case, when the earth metal fitting 40 is assembled, the earth metal fitting 40 may be elastically deformed or may not be elastically deformed.

In addition, when a snap-fit structure in which the first interlock part 21g can be elastically deformed is employed, a plurality of first interlock parts 21g may be provided. For example, in the case of two first interlock parts 21g, two first claws 21g1 are formed to protrude in a direction in which they oppose each other. Naturally, three or more first interlock parts 21g can be adopted.

In addition, the second interlock part 22b may also be caused to be elastically deformed. Namely, the second interlock part 22b employs a snap-fit structure. In this case, effects similar to those when the first interlock part 21g is elastically deformed are exhibited.

### Embodiment 5

The fuel filler port 11 according to Embodiment 5 will be described with reference to FIGS. 33 to 36. The fuel filler port main body 20 constituting the fuel filler port 11 according to Embodiment 5 differs from the fuel filler port main body 20 according to Embodiment 3 in that a pair of third interlock parts 21h and 21j are newly included. The configuration is otherwise similar thereto.

The main tube part 21 constituting the fuel filler port main body 20 further includes the pair of third interlock parts 21h and 21j. The pair of third interlock parts 21h and 21j are formed in the outlet side non-arc surface 21e in the main tube part 21 or in the vicinity of the outlet side non-arc surface 21e of the arc surface main body 21b. Each of the pair of third interlock parts 21h and 21j is provided to protrude radially outward of the main tube part 21 from the outer circumferential surface of the main tube part 21. Moreover, each of the pair of third interlock parts 21h and 21j is provided to protrude radially outward of the main tube part 21 from one of both outward sides of the connection extension part 42 of the earth metal fitting 40 in the width direction beyond a portion in which the connection extension part 42 of the earth metal fitting 40 is disposed in the outlet side non-arc surface 21e.

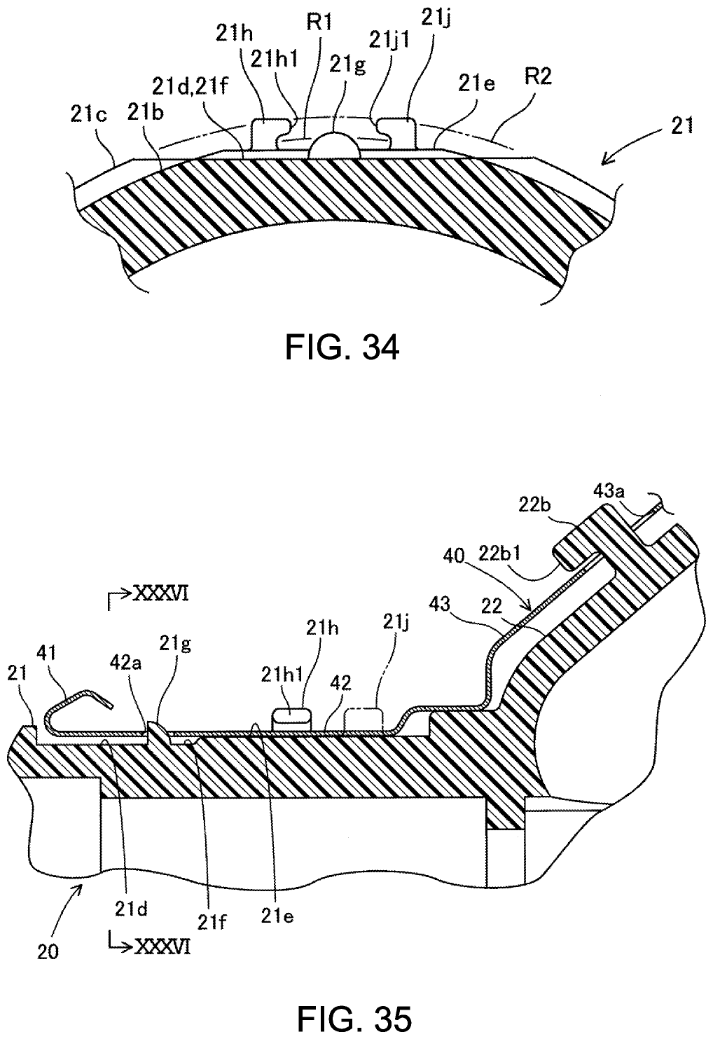

Moreover, the pair of third interlock parts 21h and 21j include third claws 21h1 and 21j1 at tips thereof. The third claws 21h1 and 21j1 are formed to protrude toward a portion in which the connection extension part 42 of the earth metal fitting 40 is disposed. As illustrated in FIG. 34, when the main tube part 21 is viewed in the axial direction, the third claw 21h1 of the third interlock part 21h on one side and the third claw 21j1 of the third interlock part 21j on the other side protrude in a direction in which they face each other.

In addition, as illustrated in FIG. 34, when the main tube part 21 is viewed in the axial direction, an interval between base ends of the pair of third interlock parts 21h and 21j is formed to be longer than the width of the connection extension part 42 of the earth metal fitting 40. Therefore, the connection extension part 42 of the earth metal fitting 40 can be disposed between the base ends of the pair of third interlock parts 21h and 21j. Moreover, when the main tube part 21 is viewed in the axial direction, the interval between the third claws 21h1 and 21j1 of the pair of third interlock parts 21h and 21j is formed to be shorter than the width of the connection extension part 42 of the earth metal fitting 40. Moreover, as illustrated in FIG. 33, the third interlock part 21h on one side and the third interlock part 21j on the other side are formed at different positions in the axial direction of the main tube part 21.

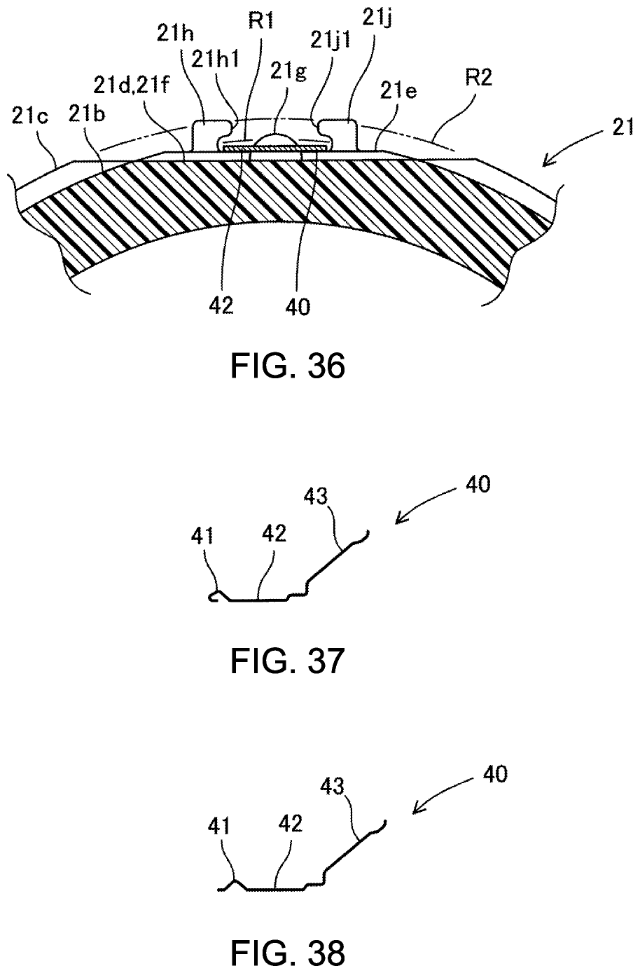

As illustrated in FIGS. 35 and 36, in a state in which the earth metal fitting 40 is assembled in the fuel filler port main body 20, the connection extension part 42 of the earth metal fitting 40 is located between the pair of third interlock parts 21h and 21j. At this time, each of the third claws 21h1 and 21j1 of the pair of third interlock parts 21h and 21j is interlocked with one of both side edges of the connection extension part 42 of the earth metal fitting 40 in the width direction. Namely, each of the third claws 21h1 and 21j1 restricts separation of the connection extension part 42 of the earth metal fitting 40 radially outward of the main tube part 21.

Here, the third interlock part 21h on one side and the third interlock part 21j on the other side are formed at different positions in the axial direction of the main tube part 21. Therefore, the earth metal fitting 40 can be assembled in the fuel filler port main body 20 by causing the connection extension part 42 of the earth metal fitting 40 to be in a state of having an angle with respect to the main tube part 21. Thereafter, the first interlock part 21g can be interlocked with the first interlocked part 42a, and the second interlock part 22b can be interlocked with the second interlocked part 43a.

In addition, the pair of third interlock parts 21h and 21j are formed at positions different from the first interlock part 21g in the axial direction of the main tube part 21. The first interlock part 21g is located at a position facing the inner circumferential surface of the outer tube part 31 of the inlet metal fitting 30 in the radial direction. Namely, there is a need for the first interlock part 21g to be located radially inside the inner diameter of the outer tube part 31 of the inlet metal fitting 30. In contrast, the pair of third interlock parts 21h and 21j is located in a region in which the inlet metal fitting 30 is not present. Therefore, the pair of third interlock parts 21h and 21j do not have any limitation on a relationship with the outer tube part 31 of the inlet metal fitting 30. As a result, the amount of protrusion of the pair of third interlock parts 21h and 21j can be made larger than that of the first interlock part 21g. Namely, the third claws 21h1 and 21j1 of the pair of third interlock parts 21h and 21j can be made large, and thus an interlocking force with respect to the connection extension part 42 of the earth metal fitting 40 can be strengthened.

In the foregoing embodiments, the main tube part 21 includes the pair of third interlock parts 21h and 21j but may include only one of the pair of third interlock parts 21h and 21j. In addition, the pair of third interlock parts 21h and 21j are located at different positions in the axial direction of the main tube part 21 but may be located the same position. Moreover, the main tube part 21 includes the first interlock part 21g and the pair of third interlock parts 21h and 21j. Furthermore, the main tube part 21 may include the pair of third interlock parts 21h and 21j without including the first interlock part 21g. In this case as well, the main tube part 21 may include only one of the pair of third interlock parts 21h and 21j. In addition, the first interlock part 21g can be replaced with the structure described in Embodiment 4.

### Embodiment 6

The fuel filler port 11 according to Embodiment 6 will be described with reference to FIG. 37. The tip bent part 41 of the earth metal fitting 40 constituting the fuel filler port 11 according to Embodiments 1 to 5 is formed to have a U-shaped cross section in the axial direction, and the free end side is caused to abut the inner circumferential surface of the outer tube part 31 of the inlet metal fitting 30. In contrast, in the fuel filler port 11 according to Embodiment 6, the tip bent part 41 is formed to have a U-shaped cross section in the axial direction, and the free end side is located on the outer circumferential surface side of the main tube part 21 of the fuel filler port main body 20. In this case, the tip bent part 41 is elastically deformed, and therefore the tip bent part 41 is disposed in a state of having a biasing force with respect to both between the outer circumferential surface of the main tube part 21 of the fuel filler port main body 20 and the inner circumferential surface of the outer tube part 31 of the inlet metal fitting 30.

### Embodiment 7

The fuel filler port 11 according to Embodiment 7 will be described with reference to FIG. 38. The tip bent part 41 of the earth metal fitting 40 constituting the fuel filler port 11 according to Embodiments 1 to 6 is formed to have a U-shaped cross section in the axial direction. In contrast, in the fuel filler port 11 according to Embodiment 7, the tip bent part 41 is formed to be bent in a mountain shape and has an elastically deformable configuration. In this case, the tip bent part 41 is elastically deformed, and therefore the tip bent part 41 is disposed in a state of having a biasing force with respect to both between the outer circumferential surface of the main tube part 21 of the fuel filler port main body 20 and the inner circumferential surface of the outer tube part 31 of the inlet metal fitting 30.

(Others)

In the foregoing description, the first interlock part 21g, and the second interlock part 22b are provided as projections and the first interlocked part 42a and the second interlocked part 43a are provided as penetration holes. However, the concavo-convex relationship therebetween may be reversed, or both may be projections. In addition, one of the first interlock part 21g and the first interlocked part 42a or one of the second interlock part 22b and the second interlocked part 43a may be a recessed part having a bottom surface instead of a penetration hole. In addition, the fuel filler port main body 20 and the earth metal fitting 40 are provided in two interlock places, but may be provided in one place or three or more places. In addition, the second interlock part 22b can also employ various structures for the first interlock part 21g. Moreover, the second interlock part 22b can also employ the structure of the third interlock parts 21h and 21j.

The disclosure provides a fuel filler port in which cost reduction can be achieved and an earth route can be reliably secured, and a method of manufacturing the same.

According to a fuel filler port of one aspect of the disclosure, by bending and forming the tip bent part of the earth metal fitting, a configuration having a biasing force in the radial direction is realized. Further, the tip bent part of the earth metal fitting is disposed between the outer circumferential surface of the fuel filler port main body and the inner circumferential surface of the outer tube part of the inlet metal fitting in the radial direction in a state of having a biasing force with respect to the inner circumferential surface of the outer tube part of the inlet metal fitting. Therefore, the tip bent part of the earth metal fitting maintains a state of always abutting the outer tube part of the inlet metal fitting due to a biasing force. Namely, an earth route from the inlet metal fitting toward the earth metal fitting is reliably secured. In addition, since the fuel filler port described above has a configuration using the earth metal fitting, there is no need for the fuel filler port main body to have a configuration of forming a conductive layer by performing two-color forming. Therefore, cost reduction of the fuel filler port can be achieved.

According to a method of manufacturing a fuel filler port of another aspect of the disclosure, the inlet metal fitting is interlocked with the outer circumferential surface of the fuel filler port main body in the axial direction by deforming the outer tube part radially inward, that is, by performing caulking. In this manner, in the fuel filler port, the structure thereof has a simple configuration by employing a caulking structure, and therefore cost reduction can be achieved. Further, in the fuel filler port having this simple configuration, the tip bent part of the earth metal fitting is disposed in a state of being biased between the inner circumferential surface of the inlet metal fitting and the outer circumferential surface of the fuel filler port main body in the radial direction. Namely, in the fuel filler port, cost reduction can be achieved and an earth route can be reliably secured.

What is claimed is:

1. A fuel filler port comprising:
a fuel filler port main body made of resin, formed in a tubular shape and having an interlock part on an outer circumferential surface thereof;
an inlet metal fitting at least having an outer tube part, the outer tube part being formed in a tubular shape, positioned and disposed in the fuel filler port main body, and disposed to face the outer circumferential surface of the fuel filler port main body in a radial direction; and
an earth metal fitting formed in a plate shape and interlocked with the interlock part of the fuel filler port main body,
wherein the earth metal fitting comprises
a tip bent part disposed between the outer circumferential surface of the fuel filler port main body and an inner circumferential surface of the outer tube part of the inlet metal fitting in the radial direction and disposed in a state of having a biasing force in the radial direction with respect to the inner circumferential surface of the outer tube part of the inlet metal fitting.

2. The fuel filler port according to claim 1,
wherein the outer circumferential surface of the fuel filler port main body comprises
an arc surface formed in a portion of the outer circumferential surface in a circumferential direction, and
a non-arc surface formed in the remaining portion of the outer circumferential surface in the circumferential direction and located radially inside a virtual arc surface having the same diameter as the arc surface, and
wherein the earth metal fitting further comprises
a connection extension part connected to the tip bent part and disposed to extend in an axial direction of the fuel filler port main body on the non-arc surface.

3. The fuel filler port according to claim 2,
wherein the connection extension part of the earth metal fitting is disposed between the non-arc surface and the virtual arc surface.

4. The fuel filler port according to claim 2,
wherein the tip bent part of the earth metal fitting is disposed between the non-arc surface of the fuel filler port main body and the inner circumferential surface of the outer tube part of the inlet metal fitting in the radial direction and disposed in a state of having a biasing force in the radial direction with respect to the inner circumferential surface of the outer tube part of the inlet metal fitting.

5. The fuel filler port according to claim 2,
wherein the interlock part of the fuel filler port main body comprises a first interlock part, the first interlock part being provided to protrude from the non-arc surface radially outward of the fuel filler port main body and located in a region radially inside the virtual arc surface at the same position in the fuel filler port main body in the axial direction.

6. The fuel filler port according to claim 5,
wherein the first interlock part is provided at a central part of a width of the fuel filler port main body in the circumferential direction on the non-arc surface and has a first claw at a tip thereof,
wherein the earth metal fitting is formed in an elongated plate shape,
wherein the earth metal fitting has a first interlocked part that is a penetration hole configured to allow the first interlock part to be inserted therethrough at a central part in a width direction, and
wherein the first claw of the first interlock part is configured to be interlocked with an edge of the penetration hole that is the first interlocked part of the earth metal fitting and to restrict separation of the earth metal fitting radially outward of the fuel filler port main body.

7. The fuel filler port according to claim 6,
wherein the interlock part of the fuel filler port main body further comprises a second interlock part,
wherein the second interlock part is provided to protrude radially outward from the outer circumferential surface of the fuel filler port main body, is provided at a different position from the first interlock part, and has a second claw at a tip thereof,
wherein the earth metal fitting has a second interlocked part that is a penetration hole configured to allow the second interlock part to be inserted therethrough at a different position from the first interlocked part in a longitudinal direction of the earth metal fitting and at the central part of the earth metal fitting in the width direction,
wherein the second claw of the second interlock part is configured to be interlocked with an edge of the penetration hole that is the second interlocked part of the earth metal fitting and to restrict separation of the earth metal fitting radially outward of the fuel filler port main body, and
wherein the first claw of the first interlock part and the second claw of the second interlock part are configured to protrude in a counter direction or an opposing direction in the longitudinal direction of the earth metal fitting.

8. The fuel filler port according to claim 2,
wherein the earth metal fitting is formed in an elongated plate shape,
wherein the interlock part of the fuel filler port main body comprises a third interlock part,
wherein the third interlock part is provided to protrude from the outer circumferential surface of the fuel filler port main body radially outward of the fuel filler port main body, is provided to protrude from outside of the earth metal fitting in the width direction radially outward of the fuel filler port main body, and has a third claw at a tip thereof, and
wherein the third claw of the third interlock part is configured to be interlocked with a side edge of the earth metal fitting in the width direction and to restrict separation of the earth metal fitting radially outward of the fuel filler port main body.

9. The fuel filler port according to claim 8,
wherein the interlock part of the fuel filler port main body comprises a pair of the third interlock parts,
wherein each of the pair of the third interlock parts is provided to protrude from one of both outward sides of the earth metal fitting in the width direction radially outward of the fuel filler port, and
wherein each of the third claws of the pair of third interlock parts is interlocked with each of both side edges of the earth metal fitting in the width direction.

10. The fuel filler port according to claim 5,
wherein the arc surface of the fuel filler port main body comprises
an arc surface main body serving as a first arc surface, and
a circumferential projection serving as a second arc surface protruding radially outward beyond the arc surface main body and extending in the circumferential direction,
wherein the non-arc surface of the fuel filler port main body comprises
an inlet side non-arc surface formed at a position on an inlet opening side from the circumferential projection in the arc surface main body in the axial direction of the fuel filler port main body,
an outlet side non-arc surface formed at a position on an outlet opening side from the circumferential projection in the arc surface main body in the axial direction of the fuel filler port main body, and
a projection position non-arc surface formed at a position in the circumferential projection and between the inlet side non-arc surface and the outlet side non-arc surface in the axial direction of the fuel filler port main body, and
wherein the first interlock part of the fuel filler port main body is formed on the projection position non-arc surface.

11. The fuel filler port according to claim 2,
wherein the arc surface of the fuel filler port main body comprises
an arc surface main body serving as a first arc surface, and
a circumferential projection serving as a second arc surface protruding radially outward beyond the arc surface main body and extending in the circumferential direction, and
wherein the outer tube part of the inlet metal fitting comprises a caulking part interlocked with the circumferential projection in the axial direction.

12. The fuel filler port according to claim 11,
wherein the caulking part is formed over the whole circumference in the circumferential direction.

13. The fuel filler port according to claim 2,
wherein the arc surface of the fuel filler port main body comprises
an arc surface main body serving as a first arc surface, and
a circumferential projection serving as a second arc surface protruding radially outward beyond the arc surface main body and extending in the circumferential direction, and
wherein the outer tube part of the inlet metal fitting comprises a plurality of caulking parts interlocked with the circumferential projection in the axial direction and intermittently disposed in the circumferential direction.

14. The fuel filler port according to claim 13,
wherein at least a portion of the fuel filler port main body in the circumferential direction in the earth metal fitting faces the plurality of caulking parts in the radial direction of the fuel filler port main body.

15. The fuel filler port according to claim 13,
wherein the earth metal fitting is disposed in a gap in the circumferential direction between adjacent ones of the plurality of caulking parts in the circumferential direction of the fuel filler port main body.

16. The fuel filler port according to claim 1,
wherein the tip bent part is formed in a U-shape in a cross section of the fuel filler port main body in the axial direction, and a folded portion having a U-shape is formed to be able to be elastically deformed in the radial direction of the fuel filler port main body.

17. A method of manufacturing the fuel filler port according to claim 1, comprising:
a positioning step in which the outer tube part of the inlet metal fitting is positioned at a position facing the outer circumferential surface of the fuel filler port main body and the tip bent part of the earth metal fitting is rendered in a state of having a biasing force in the radial direction between the outer circumferential surface of the fuel filler port main body and the inner circumferential surface of the outer tube part of the inlet metal fitting in the radial direction; and
a caulking step in which the outer tube part is interlocked with the outer circumferential surface of the fuel filler port main body in the axial direction by deforming the outer tube part radially inward.
